(19) United States
(12) Patent Application Publication
(10) Pub. No.: US 2024/0280666 A1
(43) Pub. Date: Aug. 22, 2024

(54) OBJECT DETECTION APPARATUS AND OBJECT DETECTION METHOD

(71) Applicant: Mitsubishi Electric Corporation, Tokyo (JP)

(72) Inventor: Tatsuya KAMIMURA, Tokyo (JP)

(73) Assignee: Mitsubishi Electric Corporation, Tokyo (JP)

(21) Appl. No.: 18/565,096

(22) PCT Filed: Jun. 7, 2021
(86) PCT No.: PCT/JP2021/021554

§ 371 Date: Nov. 29, 2023

(51) Int. Cl. G01S 7/35; G01S 13/536; G01S 13/931

(52) U.S. Cl. CPC G01S 7/35; G01S 13/536; G01S 13/931; G01S 2013/93271

(57) ABSTRACT

An object detection apparatus includes a radar that radiates an electromagnetic wave from a vehicle and outputs a reception signal by receiving a reflected wave propagated by reflection of the electromagnetic wave, an object detector that detects, based on the reception signal, a position and a speed of an object present in an environment in which the vehicle travels, an obstacle detector that detects positions of respective obstacles on opposite sides of a route along which the vehicle travels and a separation distance that is a distance between the obstacles, and a horizontal coverage controller that controls a coverage of the radar in a horizontal direction based on the positions of the respective obstacles on the opposite sides of the route and the separation distance.

### FIELD

The present disclosure relates to an object detection apparatus and an object detection method for detecting an object present in an environment in which a vehicle travels.

### BACKGROUND

There is known a system including an object detection apparatus that detects a person or an obstacle present ahead in a traveling direction of a vehicle, and a vehicle control function or an alarm generation function for preventing collision between the person or the obstacle and the vehicle. The object detection apparatus includes a sensor such as a radar, a camera, Light Detection And Ranging (LiDAR), or an ultrasonic sensor, and detects a person or an obstacle using the sensor.

Patent Literature 1 discloses an object detection apparatus that integrates a result of detecting an object using a radar and a result of detecting an object using a camera, and that determines whether a detected object is a pedestrian.

### CITATION LIST

### Patent Literature

Patent Literature 1: International Publication No. WO 2010/119860

### SUMMARY OF INVENTION

### Problem to be Solved by the Invention

In a case where a vehicle travels along a route surrounded by obstacles such as walls, fences, or pillars, the radar is affected by a phenomenon such as multipath or clutter due to reflection of electromagnetic waves from the obstacles, and thus, in some cases, accuracy in detecting a person deteriorates. Thus, according to a technique disclosed in Patent Literature 1, there is a problem that accuracy in detecting an object may deteriorate in an environment in which obstacles that obstruct the travel of the vehicle are present.

The present disclosure has been made in view of the above circumstances, and an object of the present disclosure is to provide an object detection apparatus capable of detecting an object with high accuracy in an environment in which obstacles that obstruct travel of a vehicle are present.

### Means to Solve the Problem

To solve the above problems and achieve the object, an object detection apparatus according to the present disclosure includes: a radar adapted to radiate an electromagnetic wave from a vehicle and to output a reception signal by receiving a reflected wave propagated by reflection of the electromagnetic wave; an object detector adapted to detect, based on the reception signal, a position and a speed of an object present in an environment in which the vehicle travels; an obstacle detector adapted to detect positions of respective obstacles on opposite sides of a route along which the vehicle travels and a separation distance that is a distance between the obstacles; and a horizontal coverage controller adapted to control a coverage of the radar in a horizontal direction based on the positions of the respective obstacles on the opposite sides of the route and the separation distance.

### Effects of the Invention

The object detection apparatus according to the present disclosure has an effect of being able to detect the object with high accuracy in the environment in which the obstacles that obstruct the travel of the vehicle are present.

### BRIEF DESCRIPTION OF DRAWINGS

FIG. 1 is a diagram illustrating a configuration of an object detection apparatus according to a first embodiment.

FIG. 2 is a flowchart illustrating an operation procedure of the object detection apparatus according to the first embodiment.

FIG. 3 is an explanatory diagram illustrating a first coverage in a case where an obstacle detector of the object detection apparatus according to the first embodiment detects positions of obstacles and a separation distance between the obstacles.

FIG. 4 is an explanatory diagram illustrating the detection of the positions of the obstacles and the separation distance between the obstacles performed by the obstacle detector of the object detection apparatus according to the first embodiment.

FIG. 5 is an explanatory diagram illustrating a second coverage in a case where an object detector of the object detection apparatus according to the first embodiment detects a position and a speed of an object.

FIG. 6 is a diagram illustrating a configuration of an object detection apparatus according to a second embodiment.

FIG. 7 is a flowchart illustrating an operation procedure of the object detection apparatus according to the second embodiment.

FIG. 8 is a diagram illustrating a first example of a hardware configuration of the object detection apparatus according to the first embodiment or the second embodiment.

FIG. 9 is a diagram illustrating a second example of the hardware configuration of the object detection apparatus according to the first embodiment or the second embodiment.

### DESCRIPTION OF EMBODIMENTS

Hereinafter, an object detection apparatus and an object detection method according to embodiments will be described in detail with reference to the drawings.

### First Embodiment

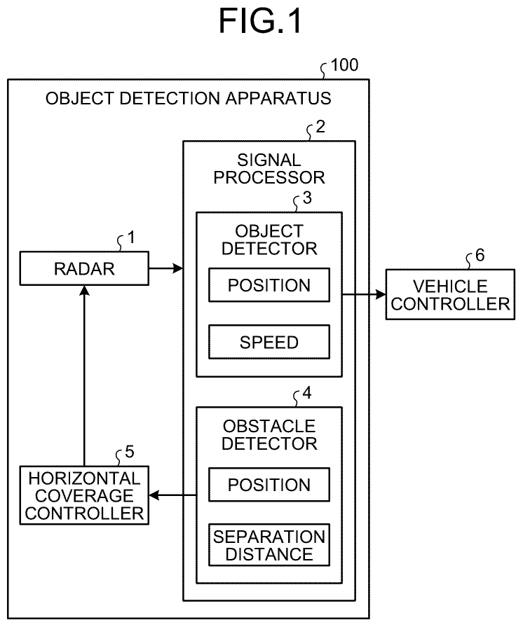

FIG. 1 is a diagram illustrating a configuration of an object detection apparatus 100 according to a first embodiment. The object detection apparatus 100 is installed in a vehicle. The vehicle includes a vehicle control function for preventing collision between an object or an obstacle and the vehicle based on a result of detecting the object or the obstacle by the object detection apparatus 100. In the first embodiment, the object detected by the object detection apparatus 100 is an object desired to be detected in order to prevent collision between the vehicle and the object, and is, for example, a person. The obstacle is an object fixed on the ground, such as a wall, a fence, a pillar, a guardrail, a shelf, or a shutter in an environment in which vehicle travels.

The object detection apparatus 100 includes: a radar 1; a signal processor 2 adapted to process a signal received from the radar 1; and a horizontal coverage controller 5 adapted to control a coverage of the radar 1. The signal processor 2 includes: an object detector 3 adapted to detect an object present in an environment in which the vehicle travels, and an obstacle detector 4 adapted to detect the obstacle.

The radar 1 radiates an electromagnetic wave from the vehicle. The radar 1 outputs a reception signal by receiving a reflected wave propagated by reflection of the electromagnetic wave from the object or the obstacle. The radar 1 is a radar of a Frequency Modulated Continuous Wave (FMCW) system or a Fast Chirp Modulation (FCM) system. The radar 1 includes components such as a high-frequency semiconductor component, a power supply semiconductor component, a substrate, a crystal device, a chip component, and an antenna. The reception signal from the radar 1 is input to each of the object detector 3 and the obstacle detector 4.

The object detector 3 detects, based on the reception signal, a position and a speed of the object present in an environment in which the vehicle travels. The object detector 3 generates position data indicating the position of the object, and speed data indicating the speed at which the object moves. The object detector 3 outputs the generated position data and speed data. The position data and the speed data are input to a vehicle controller 6. The vehicle controller 6 controls the vehicle using the position data and the speed data.

The obstacle detector 4 detects, based on the reception signal, positions of obstacles on opposite sides of a route along which the vehicle travels and a separation distance between the obstacles. The separation distance is a distance between the obstacles on the opposite sides of the route along which the vehicle travels. For example, in a case where fences extending in parallel with the route are installed on the opposite sides of the route, a distance between the fences in a direction that is perpendicular to an extending direction of the route and that is in a horizontal plane is a separation distance between the fences. The obstacle detector 4 generates position data indicating the positions of the obstacles and separation distance data indicating the separation distance. The obstacle detector 4 outputs the generated position data and separation distance data.

The position data and the separation distance data are input to the horizontal coverage controller 5. The horizontal coverage controller 5 determines a coverage in a horizontal direction based on the position data and the separation distance data, which are the detection results gained from the obstacle detector 4. The horizontal coverage controller 5 controls the coverage of the radar 1 in the horizontal direction by sending an instruction of the coverage to the radar 1.

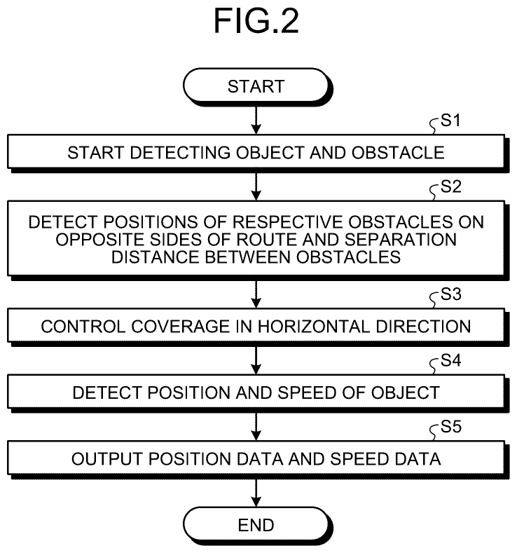

Operation of the object detection apparatus 100 will next be described. FIG. 2 is a flowchart illustrating an operation procedure of the object detection apparatus 100 according to the first embodiment. Description will now be given of the operation of the object detection apparatus 100 in a case where there are obstacles on the opposite sides of the route along which the vehicle travels. In the following description, a frame is a cycle of detecting an object and an obstacle. FIG. 2 illustrates a procedure of the operation of the object detection apparatus 100 in one frame.

In step S1, the object detection apparatus 100 starts detecting an object and an obstacle. The radar 1 radiates an electromagnetic wave and outputs a reception signal by receiving a reflected wave propagated by reflection of the electromagnetic wave from an object or an obstacle. For the coverage of the radar 1 in step S1, a first coverage is set that covers a wide angle range so as to be able to detect an obstacle present ahead in the traveling direction of the vehicle.

In the case where there are obstacles on the opposite sides of the route along which the vehicle travels, in step S2, the obstacle detector 4 of the object detection apparatus 100 detects, based on the reception signal, the positions of the respective obstacles on the opposite sides of the route and the separation distance between the obstacles on the opposite sides of the route. The obstacle detector 4 outputs the position data and the separation distance data.

In step S3, the horizontal coverage controller 5 of the object detection apparatus 100 controls the coverage in the horizontal direction based on the position data and the separation distance data about the obstacles. The horizontal coverage controller 5 performs control to reduce the coverage from the first coverage, in which the respective obstacles on the opposite sides of the route are detected, to the second coverage between the obstacles.

In step S4, the object detector 3 of the object detection apparatus 100 detects the position and the speed of the object based on the reception signal received after the coverage is reduced to the second coverage. That is, the object detector 3 detects the position and the speed of the object based on the reception signal output by receiving the reflected wave in the coverage controlled in step S3. The object detector 3 outputs the position data and speed data.

In step S5, the object detector 3 outputs the position data and the speed data to the vehicle controller 6. Thus, the object detection apparatus 100 ends the operation in accordance with the procedure illustrated in FIG. 2. Thereafter, the operation of the object detection apparatus 100 proceeds to operation of a next frame. The vehicle controller 6 controls the vehicle using the position data and speed data received from the object detection apparatus 100.

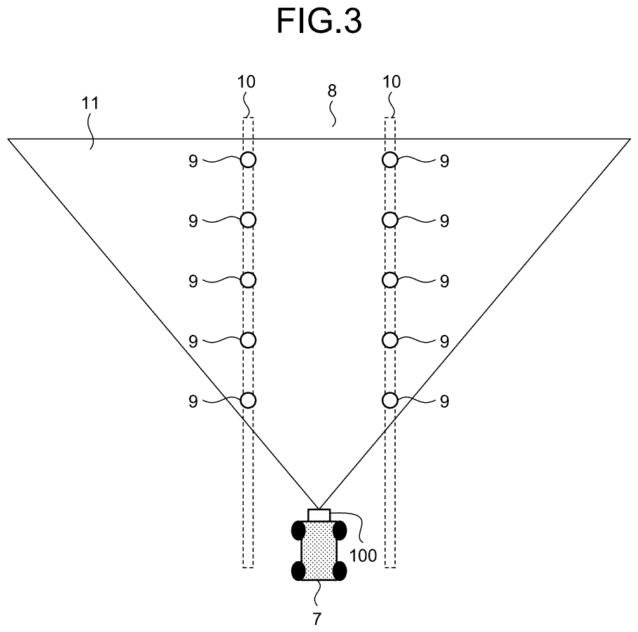

FIG. 3 is an explanatory diagram illustrating the first coverage in the case where the obstacle detector 4 of the object detection apparatus 100 according to the first embodiment detects the positions of the obstacles and the separation distance between the obstacles. FIG. 3 illustrates a state in which a vehicle 7, a route 8 along which the vehicle 7 travels, and obstacles on opposite sides of the route 8 are viewed from above the vehicle 7.

The object detection apparatus 100 is installed in a front portion of the vehicle 7. In FIG. 3, a plurality of pillars 9 as obstacles are installed on each of a right side and a left side of the route 8 as viewed from the vehicle 7. The plurality of pillars 9 installed on the right side of the route 8 are disposed in parallel with the route 8. The plurality of pillars 9 installed on the left side of the route 8 are disposed in parallel with the route 8. FIG. 3 also illustrates a case where walls 10 as obstacles are installed instead of the pillars 9. In FIG. 3, broken lines represent a state in which the respective walls 10 extending in parallel with the route 8 are installed on the right side and the left side of the route 8. A first coverage 11 covers the plurality of pillars 9 or the walls 10 that are the respective obstacles on the opposite sides of the route 8.

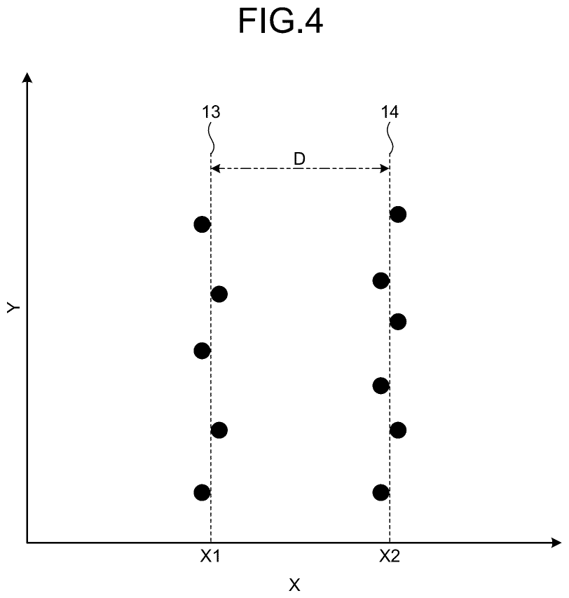

FIG. 4 is an explanatory diagram illustrating the detection of the positions of the obstacles and the separation distance between the obstacles performed by the obstacle detector 4 of the object detection apparatus 100 according to the first embodiment. The obstacle detector 4 detects the obstacles as a result of receiving a reflected wave stronger than that received from the surroundings by the radar 1. FIG. 4 illustrates, in a graph, an example of detection results indicating the positions in which the obstacles have been detected by the obstacle detector 4. Here, a direction perpendicular to an extending direction of the route 8 and in a horizontal plane is defined as an X direction, and the extending direction of the route 8 is defined as a Y direction. A horizontal axis of the graph represents a position in the X direction. A horizontal axis of the graph represents a position in the Y direction.

The obstacle detector 4 determines positions of edges of the obstacles by applying, for example, Hough transform processing to the detection results illustrated in FIG. 4. A broken line 13 illustrated in FIG. 4 represents edges of the obstacles installed on the left side of the route 8. A broken line 14 illustrated in FIG. 4 represents edges of the obstacles installed on the right side of the route 8. In the case where the obstacles are the plurality of pillars 9, the broken lines 13 and 14 represent lines connecting edges of the respective pillars 9 in the X direction. In the case where the obstacles are the walls 10, the broken lines 13 and 14 represent edges of the walls 10 in the X direction. The obstacle detector 4 estimates, as the positions of the obstacles, a position X1 of the edges represented by the broken line 13 and a position X2 of the edges represented by the broken line 14. The obstacle detector 4 estimates, as the separation distance, a distance D between the edges represented by the broken line 13 and the edges represented by the broken line 14. In this manner, the obstacle detector 4 detects the positions of the obstacles on the opposite sides of the route 8 and the separation distance between the obstacles.

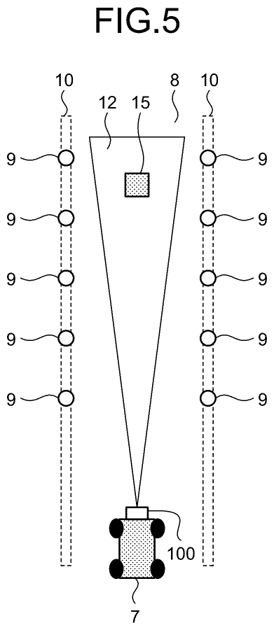

FIG. 5 is an explanatory diagram illustrating a second coverage in the case where the object detector 3 of the object detection apparatus 100 according to the first embodiment detects the position and the speed of the object. The horizontal coverage controller 5 performs adjustment to reduce the coverage from the first coverage 11 to a second coverage 12 based on the positions of the respective obstacles on the opposite sides of the route 8 and the separation distance between the obstacles. The second coverage 12 is a coverage limited between the obstacles.

By the control to reduce the coverage, the object detection apparatus 100 can reduce the incidence of the electromagnetic wave on the obstacles in detecting the position and the speed of the object in the route 8. As a result, the object detection apparatus 100 can reduce a phenomenon such as multipath or clutter due to reflection of the electromagnetic wave from the obstacles in the case where the vehicle 7 travels along the route surrounded by the obstacles. The object detection apparatus 100 can detect the position and the speed of a person with high accuracy, for example, even in a case where the person is right next to the obstacle.

As described above, the object detection apparatus 100 according to the first embodiment has an effect of being able to detect the object with high accuracy in the environment in which the obstacles that obstruct the travel of the vehicle are present.

### Second Embodiment

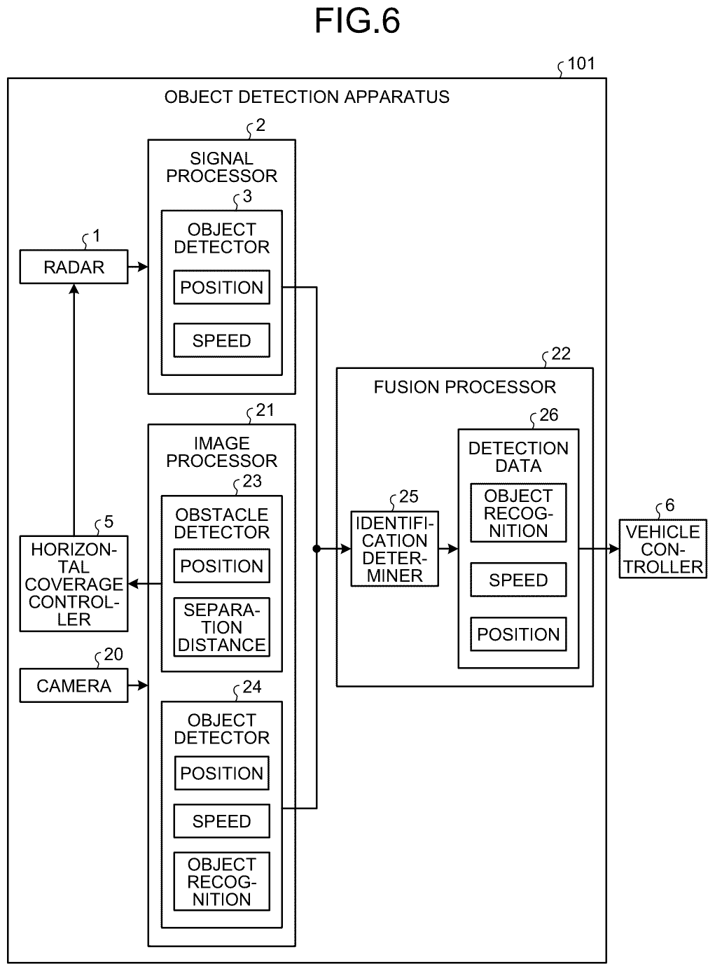

FIG. 6 is a diagram illustrating a configuration of an object detection apparatus 101 according to a second embodiment. The object detection apparatus 101 performs an identical determination process of determining whether an object detected using the radar 1 is identical to an object detected using a camera 20. In the second embodiment, the same components as those in the first embodiment are denoted by the same reference numerals and signs, and configurations different from those in the first embodiment will be mainly described.

The object detection apparatus 101 is installed in the vehicle 7 similarly to the object detection apparatus 100 illustrated in FIGS. 3 and 5. In the second embodiment, the object detected by the object detection apparatus 101 is an object desired to be detected in order to prevent collision between the vehicle 7 and the object.

The object detection apparatus 101 includes: the radar 1; the signal processor 2 that processes a signal received from the radar 1; and the horizontal coverage controller 5 that controls a coverage of the radar 1. The signal processor 2 includes the object detector 3 adapted to detect a position and a speed of an object present in an environment in which the vehicle 7 travels. The object detector 3 that is a first object detector detects the position and the speed of the object based on the reception signal from the radar 1. The object detector 3 generates position data indicating the position of the object, and speed data indicating the speed at which the object moves. The object detector 3 outputs the generated position data and speed data.

Furthermore, the object detection apparatus 101 includes: the camera 20; an image processor 21 that performs image recognition processing; and a fusion processor 22. The image processor 21 includes: an obstacle detector 23 that detects positions of the obstacles and a separation distance between obstacles; and an object detector 24 that detects a position and a speed of an object present in an environment in which the vehicle 7 travels.

The camera 20 captures, by imaging from the vehicle 7, an image of an environment ahead in the traveling direction of the vehicle 7, and outputs an image signal. The obstacle detector 23 recognizes obstacles included in the image captured by the imaging from the vehicle 7. The object detector 24 recognizes an object included in the image captured by the imaging from the vehicle 7. The obstacle detector 23 recognizes the obstacles included in the image based on a feature obtained from the image and a database of feature data about various obstacles. The object detector 24 recognizes the object included in the image based on a feature obtained from the image and a database of feature data about an object such as a person. The feature data is acquired by machine learning or deep learning. The database of the feature data is stored in advance in the object detection apparatus 101.

The obstacle detector 23 detects the positions of the respective obstacles on the opposite sides of the route 8 and the separation distance, which is the distance between the obstacles, based on the image in which the obstacles on the opposite sides of the route 8 are included. The obstacle detector 23 generates position data indicating the positions of the obstacles and separation distance data indicating the separation distance. The obstacle detector 23 outputs the generated position data and separation distance data.

The object detector 24 that is a second object detector detects the position and the speed of the object based on the image in which the object present in an environment in which the vehicle 7 travels is included. The object detector 24 generates position data indicating the position of the object, and speed data indicating a speed at which the object moves. Furthermore, the object detector 24 generates object recognition data indicating a result of recognizing the object included in the image. The object recognition data represents a category of the object whose position and speed have been detected.

The fusion processor 22 includes an identification determiner 25. The position data and the speed data generated by the object detector 3 are input to the identification determiner 25. The position data, the speed data, and the object recognition data generated by the object detector 24 are input to the identification determiner 25.

The identification determiner 25 determines whether the object whose position and speed have been detected by the object detector 3 is identical to the object recognized by the object detector 24. That is, the identification determiner 25 performs an identical determination process of determining whether the object detected using the radar 1 is identical to the object detected using the camera 20. The identification determiner 25 compares the position data and the speed data received from the object detector 3 with the position data and the speed data received from the object detector 24, thus determining whether the object detected using the radar 1 is identical to the object detected using the camera 20.

In a case where the identification determiner 25 has determined that the object whose position and speed have been detected by the object detector 3 is identical to the object recognized by the object detector 24, the identification determiner 25 associates the object recognition data received from the object detector 24 with the position data and the speed data received from the object detector 3. Thus, the identification determiner 25 generates detection data 26 that is data in which the object recognition data is associated with the position data and the speed data. The fusion processor 22 outputs the generated detection data 26 to the outside of the object detection apparatus 101. The detection data 26 is input to the vehicle controller 6. The vehicle controller 6 controls the vehicle 7 using the detection data 26.

The position data and the separation distance data generated by the obstacle detector 23 are input to the horizontal coverage controller 5. The horizontal coverage controller 5 determines the coverage in the horizontal direction based on the position data and the separation distance data, which are the detection results obtained from the obstacle detector 23. The horizontal coverage controller 5 controls the coverage of the radar 1 in the horizontal direction by sending an instruction of the coverage to the radar 1.

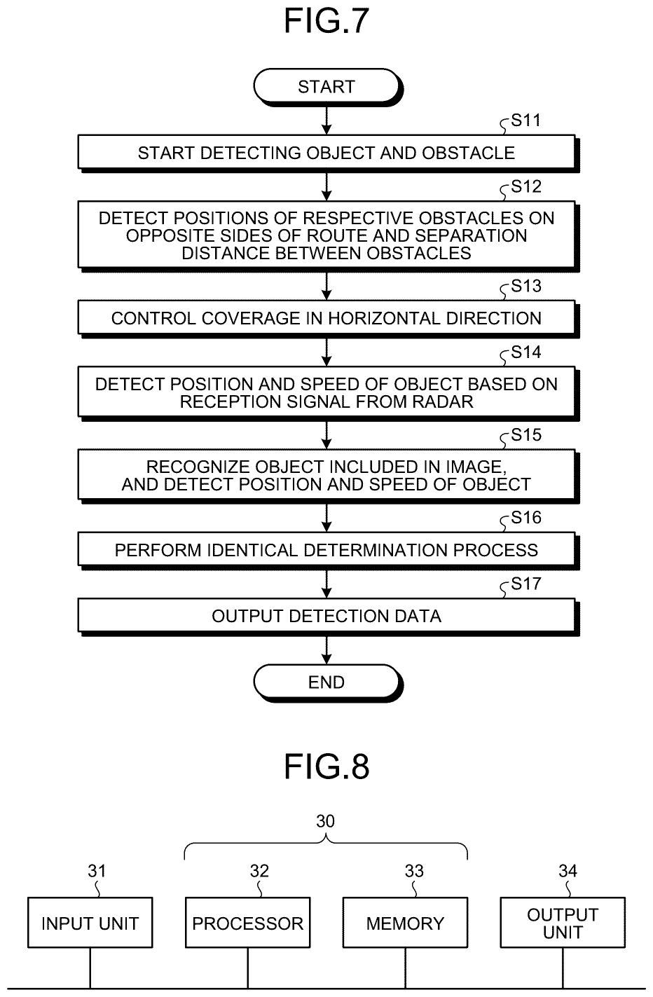

Next, operation of the object detection apparatus 101 will be described. FIG. 7 is a flowchart illustrating an operation procedure of the object detection apparatus 101 according to the second embodiment. Description will now be given of the operation of the object detection apparatus 101 in the case where there are obstacles on the opposite sides of the route along which the vehicle 7 travels. FIG. 7 illustrates a procedure of the operation of the object detection apparatus 101 in one frame.

In step S11, the object detection apparatus 101 starts detecting an object and an obstacle. The radar 1 radiates an electromagnetic wave and outputs a reception signal by receiving a reflected wave propagated by reflection of the electromagnetic wave from an object or an obstacle. For the coverage of the radar 1 in step S11, the first coverage 11 is set that covers a wide angle range so as to be able to detect an obstacle present ahead in the traveling direction of the vehicle 7.

In the case where there are obstacles on the opposite sides of the route along which the vehicle 7 travels, in step S12, the obstacle detector 23 of the object detection apparatus 101 detects, based on the image captured by the camera 20, the positions of the respective obstacles on the opposite sides of the route 8 and the separation distance between the obstacles on the opposite sides of the route 8. The obstacle detector 23 outputs the position data and the separation distance data.

In step S13, the horizontal coverage controller 5 of the object detection apparatus 101 controls the coverage in the horizontal direction based on the position data and the separation distance data about the obstacles. The horizontal coverage controller 5 performs control to reduce the coverage from the first coverage 11 in which the respective obstacles on the opposite sides of the route 8 are detected to the second coverage 12 between the obstacles.

In step S14, the object detector 3 of the object detection apparatus 101 detects the position and the speed of the object based on the reception signal received from the radar 1 after the coverage is reduced to the second coverage 12. That is, the object detector 3 detects the position and the speed of the object based on the reception signal output by receiving the reflected wave in the coverage controlled in step S13. The object detector 3 outputs the position data and speed data.

In step S15, the object detector 24 of the object detection apparatus 101 recognizes the object included in the image. Furthermore, in step S15, the object detector 24 detects the position and the speed of the object. The object detector 24 outputs the object recognition data, the position data, and the speed data. Note that, step S14 and step S15 may be performed in any order. Furthermore, the processing of step S14 and the processing of step S15 may be performed simultaneously.

In step S16, the identification determiner 25 of the object detection apparatus 101 performs the identical determination process. In the case where the identification determiner 25 has determined that the object whose position and speed have been detected by the object detector 3 is identical to the object recognized by the object detector 24, the identification determiner 25 associates the object recognition data received from the object detector 24 with the position data and the speed data received from the object detector 3. Thus, the identification determiner 25 generates the detection data 26 that is the data in which the object recognition data is associated with the position data and the speed data.

In step S17, the identification determiner 25 outputs the detection data 26 to the vehicle controller 6. Thus, the object detection apparatus 101 ends the operation in accordance with the procedure illustrated in FIG. 7. Thereafter, the operation of the object detection apparatus 101 proceeds to operation of a next frame. The vehicle controller 6 controls the vehicle 7 using the detection data 26 received from the object detection apparatus 101.

By the control to reduce the coverage, the object detection apparatus 101 can reduce the incidence of the electromagnetic wave on the obstacles in detecting the position and the speed of the object in the route 8. As a result, the object detection apparatus 101 can reduce a phenomenon such as multipath or clutter due to reflection of the electromagnetic wave from the obstacles in the case where the vehicle 7 travels along the route surrounded by the obstacles. The object detection apparatus 101 can detect the position and the speed of a person with high accuracy, for example, even in a case where the person is right next to the obstacle.

As described above, the object detection apparatus 101 according to the second embodiment has an effect of being able to detect the object with high accuracy in the environment in which the obstacles that obstruct the travel of the vehicle are present.

A hardware configuration of the object detection apparatus 100 or 101 will next be described. The respective functions of the signal processor 2, the horizontal coverage controller 5, the image processor 21, and the fusion processor 22 are implemented using a processing circuit. The processing circuit includes a processor that executes a program stored in a memory. Alternatively, the processing circuit is dedicated hardware incorporated into the object detection apparatus 100 or 101.

FIG. 8 is a diagram illustrating a first example of the hardware configuration of the object detection apparatus 100 according to the first embodiment or the object detection apparatus 101 according to the second embodiment. The first example is an example of a case where the signal processor 2 and the horizontal coverage controller 5 that are main parts of the object detection apparatus 100, and the signal processor 2, the horizontal coverage controller 5, the image processor 21, and the fusion processor 22 that are main parts of the object detection apparatus 101 are implemented by a processing circuit 30 including a processor 32 and a memory 33.

The processor 32 is a Central Processing Unit (CPU). The processor 32 may be an arithmetic unit, a microprocessor, a microcomputer, or a Digital Signal Processor (DSP). The memory 33 is, for example, a Random Access Memory (RAM), a Read Only Memory (ROM), a flash memory, an Erasable Programmable Read Only Memory (EPROM), an Electrically Erasable Programmable Read Only Memory (EEPROM; registered trademark), or the like.

The memory 33 stores a program for operating as processing units that are the main parts of the object detection apparatus 100 or 101. The main parts of the object detection apparatus 100 or 101 can be implemented by the processor 32 reading and executing the program.

An input unit 31 is a circuit that receives, from the outside, input signals toward the processing units that are the main parts of the object detection apparatus 100 or 101. The reception signal from the radar 1 is input to the input unit 31 of the object detection apparatus 100. The reception signal from the radar 1 and the image signal from the camera 20 are input to the input unit 31 of the object detection apparatus 101.

An output unit 34 is a circuit that outputs, to the outside, signals generated by the processing units that are main parts of the object detection apparatus 100 or 101. The output unit 34 of the object detection apparatus 100 outputs the position data and the speed data to the vehicle controller 6. The output unit 34 of the object detection apparatus 101 outputs the detection data 26 to the vehicle controller 6. Additionally, the output unit 34 of the object detection apparatus 100 or 101 outputs, to the radar 1, a signal for controlling the coverage.

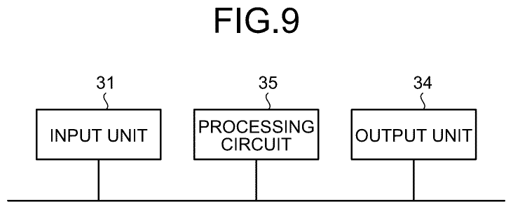

FIG. 9 is a diagram illustrating a second example of the hardware configuration of the object detection apparatus 100 according to the first embodiment or the object detection apparatus 101 according to the second embodiment. The second example is an example of a case where the main parts of the object detection apparatus 100 or 101 are implemented by a dedicated processing circuit 35.

The processing circuit 35 is a single circuit, a composite circuit, an Application Specific Integrated Circuit (ASIC), a Field Programmable Gate Array (FPGA), or a circuit obtained by combining these circuits. Some of the functions of the processing units that are the main parts of the object detection apparatus 100 or 101 may be implemented by the processor 32 and the memory 33, and the remaining functions may be implemented by the dedicated processing circuit 35.

The configurations described in the above embodiments are an example of the contents of the present disclosure. The configurations of the above embodiments may be combined with another known technique. The configurations of the above embodiments may be appropriately combined with each other. Some of the configurations of the above embodiments may be omitted or changed without departing from the gist of the present disclosure.

### REFERENCE SIGNS LIST

1 radar; 2 signal processor; 3, 24 object detector; 4, 23 obstacle detector; 5 horizontal coverage controller; 6 vehicle controller; 7 vehicle; 8 route; 9 pillar; 10 wall; 11 first coverage; 12 second coverage; 13, 14 broken line; 20 camera; 21 image processor; 22 fusion processor; 25 identification determiner; 26 detection data; 30, 35 processing circuit; 31 input unit; 32 processor; 33 memory; 34 output unit; 100, 101 object detection apparatus.

1. An object detection apparatus comprising:
a radar adapted to radiate an electromagnetic wave from a vehicle and to output a reception signal by receiving a reflected wave propagated by reflection of the electromagnetic wave;
an object detector adapted to detect, based on the reception signal, a position and a speed of an object present in an environment in which the vehicle travels;
an obstacle detector adapted to detect positions of respective obstacles on opposite sides of a route along which the vehicle travels and a separation distance that is a distance between the obstacles; and
a horizontal coverage controller adapted to perform control to reduce a coverage of the radar in a horizontal direction from a first coverage, in which the respective obstacles on the opposite sides of the route are detected, to a second coverage between the obstacles based on the positions of the respective obstacles on the opposite sides of the route and the separation distance.

2. The object detection apparatus according to claim 1, wherein
the horizontal coverage controller is adapted to reduce incidence of the electromagnetic wave on the obstacles by the control to reduce the coverage.

3. The object detection apparatus according to claim 1, further comprising:
a first object detector that is the object detector;
a second object detector adapted to recognize an object included in an image captured by imaging from the vehicle; and
an identification determiner:
adapted to determine whether the object whose position and speed have been detected by the first object detector is identical to the object recognized by the second object detector; and
adapted to associate a result of recognizing the object by the second object detector with a result of detecting the position and the speed by the first object detector.

4. An object detection method for detecting, by an object detection apparatus including a radar, an object present in an environment in which a vehicle travels, the object detection method comprising:
causing the radar adapted to radiate an electromagnetic wave from the vehicle, and to output a reception signal by receiving a reflected wave propagated by reflection of the electromagnetic wave;
detecting positions of respective obstacles on opposite sides of a route along which the vehicle travels and a separation distance that is a distance between the obstacles;
performing control to reduce a coverage of the radar in a horizontal direction from a first coverage, in which the respective obstacles on the opposite sides of the route are detected, to a second coverage between the obstacles, based on the positions of the respective obstacles on the opposite sides of the route and the separation distance; and
detecting a position and a speed of the object based on the reception signal output by receiving the reflected wave in the coverage controlled.

5. The object detection apparatus according to claim 2, further comprising:
a first object detector that is the object detector;
a second object detector adapted to recognize an object included in an image captured by imaging from the vehicle; and
an identification determiner:
adapted to determine whether the object whose position and speed have been detected by the first object detector is identical to the object recognized by the second object detector; and
adapted to associate a result of recognizing the object by the second object detector with a result of detecting the position and the speed by the first object detector.
